(19) United States
(12) Patent Application Publication
(10) Pub. No.: US 2013/0287875 A1
(43) Pub. Date: Oct. 31, 2013

(54) FLUID FEEDER AND TIRE CURING DEVICE

(71) Applicant: Naofumi Yoshimi, Fukuoka (JP)

(72) Inventor: Naofumi Yoshimi, Fukuoka (JP)

(21) Appl. No.: 13/990,492

(22) PCT Filed: Nov. 14, 2011
(86) PCT No.: PCT/JP2011/076185

§ 371 Date: Jul. 16, 2013

(30) Foreign Application Priority Data
Dec. 7, 2010 (JP) 2010-272842

(51) Int. Cl. F04D 13/06; B29D 30/06

(52) U.S. Cl. CPC F04D 13/0606; B29D 30/06
USPC 425/44; 417/423.7; 134/34

(57) ABSTRACT

A fluid feeder which is capable of removing foreign matter on the surface of a rotor is provided. The fluid feeder is provided with a rotor housing body on which a rotor housing chamber for housing a rotor of a canned electric motor is installed and a pump casing in which a fluid feeding chamber hermetically installed so as to be connected consecutively to the rotor housing chamber is installed and an impeller is housed inside the fluid feeding chamber. Further, a hollow pipe body is used to connect the vicinity of a side face of the fluid feeding chamber with an upper end of the rotor housing chamber.

### TECHNICAL FIELD

The present invention relates to a fluid feeder and a tire curing device. More specifically, the present invention relates to a fluid feeder which uses a canned motor in which a rotor is separated from a stator coil by a partition (can) and also to a tire curing device which uses the fluid feeder.

### BACKGROUND ART

There is known a fluid feeder for a heater in which hot water, high-temperature steam or a high-temperature gas, etc., is used as a heating medium (fluid) and what is called a canned electric motor is used as a driving motor (refer to Patent Document 1, for example). This fluid feeder is typically used in a tire curing device.

The above-described fluid feeder is provided with an electric motor in which a rotor is hermetically separated from a stator coil by a partition (can). The electric motor rotates an impeller, thereby sucking a fluid from a suction port, thus making it possible to exhaust the sucked fluid from an exhaust port.

Here, in the canned electric motor, the stator coil is hermetically separated by the partition. Thereby, the stator coil is isolated from a heating medium (fluid), thus making it possible to avoid troubles resulting from an influence of steam.

### PRIOR ART DOCUMENT

### Patent Document

Patent Document 1: Japanese Published Unexamined Patent Application No. 2006-22644

### SUMMARY OF THE INVENTION

### Problem to be Solved by the Invention

However, in a conventional fluid feeder, a rotor is exposed to environments high in temperature and humidity. Therefore, an outer circumference of the rotor undergoes corrosion, and rust resulting from the corrosion turns into foreign matter, which may attach to the outer circumference of the rotor. As a result, the rotor may have a reduced service life or the attached foreign matter may remain at a clearance with the partition, thereby adversely influencing rotation of the rotor.

The present invention has been made in view of the above-described problem, an object of which is to provide a fluid feeder capable of removing foreign matter on the surface of a rotor and a tire curing device which uses the fluid feeder.

### Means for Solving the Problem

In order to attain the above object, the fluid feeder of the present invention is provided with a motor which has a rotor and a stator coil disposed around the rotor, a rotor housing body which houses the rotor and has a first region hermetically separating the rotor from the stator coil, a driving shaft, one end of which is connected to the rotor, an impeller which is connected to the other end of the driving shaft, an impeller housing body which has a second region hermetically installed so as to be connected consecutively to the first region and in which the impeller is housed at the second region, a suction port which is installed on the impeller housing body to suck a fluid into the second region upon rotation of the impeller, an exhaust port which is installed on the impeller housing body to exhaust the fluid from the second region upon rotation of the impeller, and a pipe body, one end of which is connected to the first region opposite to the impeller when viewed from the rotor, the other end of which is connected to a region of the second region higher in pressure than a region installed so as to be connected consecutively to the first region upon rotation of the impeller, and which is formed internally hollow.

In this instance, the other end of the pipe body is connected to a region of the second region which is higher in pressure than a region installed so as to be connected consecutively to the first region upon rotation of the impeller. Thereby, a fluid moves from the other end of the pipe body to one end thereof and the fluid is supplied to the first region opposite to the impeller when viewed from the rotor. Then, the fluid which has been supplied to the first region opposite to the impeller when viewed from the rotor returns to the second region through a space between the rotor and the stator coil. That is, the pipe body is installed, by which the fluid passes between the rotor and the stator coil upon rotation of the impeller.

“A region of the second region which is higher in pressure than a region installed so as to be connected consecutively to the first region upon rotation of the impeller” includes, for example, “a region which is positioned downstream from the flow of a fluid generated upon rotation of the impeller from the second region installed so as to be connected consecutively to the first region.”

Further, in order to attain the above object, the fluid feeder of the present invention is provided with a motor which has a rotor and a stator coil disposed around the rotor, a rotor housing body which houses the rotor and has a first region hermetically separating the rotor from the stator coil, a driving shaft, one end of which is connected to the rotor, an impeller which is connected to the other end of the driving shaft, an impeller housing body which has a second region hermetically installed so as to be connected consecutively to the first region and in which the impeller is housed at the second region, a suction port which is installed on the impeller housing body to suck a fluid into the second region upon rotation of the impeller, an exhaust port which is installed on the impeller housing body to exhaust the fluid from the second region upon rotation of the impeller, and a fluid supplying unit which supplies the fluid inside the second region to a space between the rotor and the stator coil in association with rotation of the impeller.

In this instance, the fluid passes between the rotor and the stator coil upon rotation of the impeller by the fluid supplying unit which supplies the fluid inside the second region to a space between the rotor and the stator coil in association with rotation of the impeller.

Further, in order to attain the above object, the tire curing device of the present invention is a tire curing device which is provided with a mold, a bladder which is arranged inside the mold and constituted so as to dilate or contract by supply or discharge of a fluid, a fluid supplying pipe which is connected to the bladder and supplies the fluid to the bladder, a fluid discharging pipe which is connected to the bladder and discharges the fluid from the bladder, a communicatively connected pipe which connects the fluid supplying pipe with the fluid discharging pipe in a communicating manner, and a fluid feeder which is disposed on a circulation circuit constituted with the fluid supplying pipe, the fluid discharging pipe and the communicatively connected pipe, in which the fluid feeder is provided with a motor which has a rotor and a stator coil disposed around the rotor, a rotor housing body which houses the rotor and has a first region hermetically separating the rotor from the stator coil, a driving shaft, one end of which is connected to the rotor, an impeller which is connected to the other end of the driving shaft, an impeller housing body which has a second region hermetically installed so as to be connected consecutively to the first region and in which the impeller is housed at the second region, a suction port which is installed on the impeller housing body to suck a fluid into the second region upon rotation of the impeller, an exhaust port which is installed on the impeller housing body to exhaust the fluid from the second region upon rotation of the impeller, and a pipe body, one end of which is connected to the first region opposite to the impeller when viewed from the rotor, the other end of which is connected to a region of the second region which is higher in pressure than a region installed so as to be connected consecutively to the first region upon rotation of the impeller, and which is formed internally hollow.

In this instance, the other end of the pipe body is connected to a region of the second region which is higher in pressure than a region installed so as to be connected consecutively to the first region upon rotation of the impeller. Thereby, the fluid moves from the other end of the pipe body to one end thereof, by which the fluid is supplied to the first region opposite to the impeller when viewed from the rotor. Then, the fluid which has been supplied to the first region opposite to the impeller when viewed from the rotor passes between the rotor and the stator coil and returns to the second region. That is, the pipe body is installed, by which the fluid passes between the rotor and the stator coil upon rotation of the impeller.

Still further, in order to attain the above object, the tire curing device of the present invention is a tire curing device which is provided with a mold, a bladder which is arranged inside the mold and constituted so as to dilate or contract by supply or discharge of a fluid, a fluid supplying pipe which is connected to the bladder and supplies the fluid to the bladder, a fluid discharging pipe which is connected to the bladder and discharges the fluid from the bladder, a communicatively connected pipe which connects the fluid supplying pipe with the fluid discharging pipe in a communicating manner, and a fluid feeder which is disposed on a circulation circuit constituted with the fluid supplying pipe, the fluid discharging pipe and the communicatively connected pipe, in which the fluid feeder is provided with a motor which has a rotor and a stator coil disposed around the rotor, a rotor housing body which houses the rotor and has a first region hermetically separating the rotor from the stator coil, a driving shaft, one end of which is connected to the rotor, an impeller which is connected to the other end of the driving shaft, an impeller housing body which has a second region hermetically installed so as to be connected consecutively to the first region and in which the impeller is housed at the second region, a suction port which is installed on the impeller housing body to suck a fluid into the second region upon rotation of the impeller, an exhaust port which is installed on the impeller housing body to exhaust the fluid from the second region upon rotation of the impeller, and a fluid supplying unit which supplies the fluid inside the second region to a space between the rotor and the stator coil in association with rotation of the impeller.

In this instance, the fluid passes between the rotor and the stator coil upon rotation of the impeller by the fluid supplying unit which supplies the fluid inside the second region to a space between the rotor and the stator coil in association with rotation of the impeller.

In addition, in order to attain the above object, the tire curing device of the present invention is a tire curing device which is provided with a mold, a bladder which is arranged inside the mold and constituted so as to dilate or contract by supply or discharge of a fluid, a fluid supplying pipe which is connected to the bladder and supplies the fluid to the bladder, a fluid discharging pipe which is connected to the bladder and discharges the fluid from the bladder, a communicatively connected pipe which connects the fluid supplying pipe with the fluid discharging pipe in a communicating manner, and a fluid feeder which is disposed on a circulation circuit constituted with the fluid supplying pipe, the fluid discharging pipe and the communicatively connected pipe, in which the fluid feeder is provided with a motor which has a rotor and a stator coil disposed around the rotor, a rotor housing body which houses the rotor and has a first region hermetically separating the rotor from the stator coil, a driving shaft, one end of which is connected to the rotor, an impeller which is connected to the other end of the driving shaft, an impeller housing body which has a second region hermetically installed so as to be connected consecutively to the first region and in which the impeller is housed at the second region, a suction port which is installed on the impeller housing body to suck a fluid into the second region upon rotation of the impeller, an exhaust port which is installed on the impeller housing body to exhaust the fluid from the second region upon rotation of the impeller, and a pipe body, one end of which is connected to the first region opposite to the impeller when viewed from the rotor, the other end of which is connected to at least one of the fluid supplying pipe or the fluid discharging pipe, and which is formed internally hollow.

In this instance, where the other end of the pipe body is connected to the fluid supplying pipe, the fluid moves from the other end of the pipe body to one end thereof upon supply of the fluid from the fluid supplying pipe to the bladder. Thus, the fluid is supplied to the first region opposite to the impeller when viewed from the rotor. As a result, the fluid which has been supplied to the first region opposite to the impeller when viewed from the rotor passes between the rotor and the stator coil and arrives at the second region. That is, the pipe body is installed, the other end of which is connected to the fluid supplying pipe, by which the fluid passes between the rotor and the stator coil upon supply of the fluid to the bladder.

On the other hand, where the other end of the pipe body is connected to the fluid discharging pipe, the fluid moves from one end of the pipe body to the other end, upon discharge of the fluid from the bladder to the fluid discharging pipe. Thereby, the fluid is discharged from the first region opposite to the impeller when viewed from the rotor. Then, when the fluid is discharged from the first region opposite to the impeller when viewed from the rotor, the fluid of the second region is supplied to the first region through a space between the rotor and the stator coil, and the fluid which has been supplied to the first region is discharged through the pipe body. That is, the pipe body is installed, the other end of which is connected to the fluid discharging pipe, by which the fluid passes between the rotor and the stator coil upon discharge of the fluid from the bladder.

Where the other end of the pipe body is connected to both the fluid supplying pipe and the fluid discharging pipe, the fluid passes between the rotor and the stator coil upon supply of the fluid to the bladder, and the fluid also passes between the rotor and the stator coil upon discharge of the fluid from the bladder.

### Effects of the Invention

In the fluid feeder and the tire curing device of the present invention, the fluid passes between the rotor and the stator coil. It is, therefore, possible to remove foreign matter on the surface of the rotor.

### BRIEF DESCRIPTION OF THE DRAWINGS

FIG. 1 is a schematic sectional view which explains one example of a fluid feeder to which the present invention is applied.

FIG. 2 is a schematic diagram which explains the flow of a fluid in the one example of the fluid feeder to which the present invention is applied.

FIG. 3 is a schematic diagram which explains one example of a tire curing device to which the present invention is applied.

FIG. 4 is a schematic sectional view which explains a fluid feeder which is used in another example of the tire curing device to which the present invention is applied.

### MODE FOR CARRYING OUT THE INVENTION

Hereinafter, a description will be given of modes for executing the invention (hereinafter, referred to as “Embodiments”). The description will be given according to the following order.

1. First Embodiment (fluid feeder (1))

2. Second Embodiment (tire curing device (1))

3. Third Embodiment (tire curing device (2))

4. Fourth Embodiment (tire curing device (3))

5. Others

### 1. First Embodiment

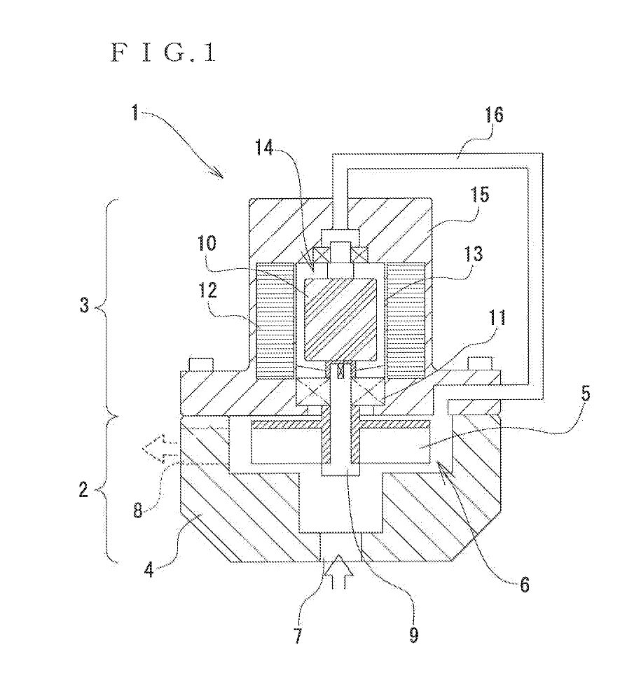

FIG. 1 is a schematic sectional view which explains one example of a fluid feeder to which the present invention is applied. A fluid feeder 1 shown here is constituted by using a driving structure based on a canned electric motor and made up of a pump portion 2 and a motor portion 3.

The pump portion 2 is constituted with a pump casing 4 and an impeller 5. In the pump casing 4, a fluid feeding chamber 6 is formed thereinside, a suction port 7 is formed at a center part thereof (bottom), and an exhaust port 8 is formed on an outer circumference (side face).

Further, the suction port 7 and the exhaust port 8 are communicatively connected to the fluid feeding chamber 6. Still further, the impeller 5 is arranged inside the fluid feeding chamber 6. A fluid is sucked from the suction port 7 upon rotation of the impeller 5, and the sucked fluid is exhausted from the exhaust port 8.

In addition, the pump casing 4 is one example of an impeller housing body, and the fluid feeding chamber 6 is one example of a second region.

Further, the impeller 5 is attached to a lower end of a pump driving shaft 9. A rotor 10 of the motor portion 3 is attached to an upper end of the pump driving shaft 9. The pump driving shaft 9 is pivotally supported by a bearing 11 formed with silicon nitride, stainless steel or the like.

The rotor 10 is a counterpart of a stator coil 12 disposed around the rotor. The rotor 10 is hermetically separated from the stator coil 12 by a partition (can) 13, thereby constituting a canned electric motor.

More specifically, a rotor housing body 15 which internally has a rotor housing chamber 14 for housing the rotor 10 is installed. And, the rotor 10 is arranged on the rotor housing chamber 14, thereby hermetically separating the rotor 10 from the stator coil 12 by the rotor housing body 15.

In addition, the rotor housing chamber 14 is just an example of the first region and a side wall of the rotor housing body 15 acts as the partition (can) 13.

Further, the rotor housing chamber 14 is communicatively connected to the fluid feeding chamber 6 through a clearance inside the bearing 11 and a clearance around the pump driving shaft 9 pivotally supported by the bearing 11. Thus, a fluid can be made to flow between the rotor housing chamber 14 and the fluid feeding chamber 6 through these clearances.

In this instance, the rotor 10 is formed with a composite material made up of a silicon steel plate, an iron plate, a silicon steel plate and an aluminum plate or the like. Further, for corrosion prevention and reduction in attachment of foreign matter, stainless steel is spray-coated on the surface of the rotor 10.

Further, the rotor housing body 15 (can 13) is formed with a non-magnetic material (such as titanium, stainless steel, plastic, aluminum, ceramics or a composite material containing them) or a weak magnetic material (such as titanium, stainless steel, plastic, aluminum, ceramics or a composite material containing them.

The fluid feeder 1 to which the present invention is applied is also provided with a hollow pipe body 16 which communicatively connects the rotor housing chamber 14 with the fluid feeding chamber 6. More specifically, one end of the pipe body 16 is connected to an upper end of the rotor housing chamber 14. And, the other end of the pipe body 16 is connected to a side opposite to an outer circumference (side face) on which the exhaust port 8 of the pump casing 4 is formed.

In addition, “an upper end of the rotor housing chamber 14” is just an example of “the first region opposite to the impeller when viewed from the rotor” and “a side opposite to an outer circumference (side face) on which the exhaust port 8 of the pump casing 4 is formed” is just an example of “a region of the second region which is higher in pressure than a region installed so as to be connected consecutively to the first region upon rotation of the impeller.”

In the above-constituted fluid feeder 1 of the First Embodiment, the canned electric motor is driven to rotate the pump driving shaft 9 attached to the rotor 10. Thereby, the impeller 5 rotates. Then, upon rotation of the impeller 5, a fluid is sucked from the suction port 7 and the sucked fluid is exhausted from the exhaust port 8.

In this instance, rotation of the impeller 5 will allow the fluid to move to the outer circumference (side face) of the pump casing 4, thus resulting in a higher pressure in the vicinity of the outer circumference. More specifically, the pressure in the vicinity of the outer circumference is higher than that at the center of the pump casing 4.

That is, the impeller 5 is rotated, by which the pressure on the outer circumference (side face) to which the other end of the pipe body 16 is connected is made higher than the pressure at a clearance around the pump driving shaft 9 which is a consecutively installed region between the rotor housing chamber 14 and the fluid feeding chamber 6.

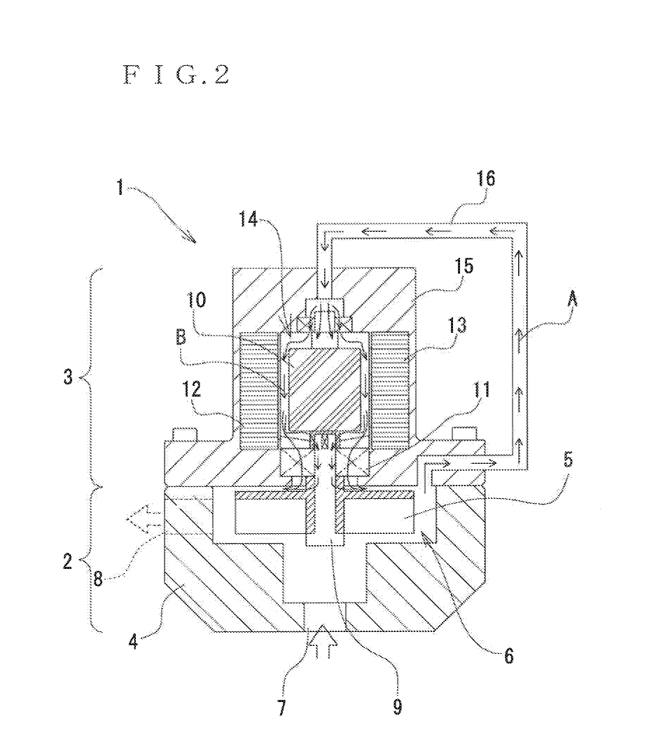

As a result, due to a difference in pressure, the fluid inside the fluid feeding chamber 6 is supplied to the rotor housing chamber 14 through the pipe body 16 as shown in FIG. 2 (refer to the symbol A in FIG. 2). The fluid which has been supplied to the rotor housing chamber 14 passes through a clearance between the rotor 10 and the partition 13 and returns into the fluid feeding chamber 6 (refer to the symbol B in FIG. 2). As described above, the fluid is supplied to the clearance between the rotor 10 and the partition 13, thus making it possible to remove foreign matter attached to the surface of the rotor 10.

Further, in the fluid feeder 1 of the First Embodiment, when the fluid feeder 1 is in operation, a fluid is constantly supplied to the clearance between the rotor 10 and the partition 13, thus making it possible to sufficiently remove foreign matter attached to the surface of the rotor 10. That is, as compared with a case where a fluid is supplied to the clearance between the rotor 10 and the partition 13 at a predetermined timing, the fluid is constantly supplied to the clearance between the rotor 10 and the partition 13. It is, thereby, possible to wash more sufficiently the surface of the rotor 10.

Further, in the fluid feeder of the First Embodiment, the other end of the pipe body 16 is connected at a position opposite to the outer circumference (side face) on which the exhaust port 8 is formed. Thereby, a greater difference in pressure is developed between the clearance around the pump driving shaft 9 and the outer circumference to which the pipe body 16 is connected, thus making it possible to efficiently supply the fluid to the rotor housing chamber 14 through the pipe body 16.

That is, in a case where the other end of the pipe body 16 is connected to the vicinity of the exhaust port 8, it is difficult to develop a higher pressure in the vicinity of the other end of the pipe body 16 due to the fact that the fluid is exhausted from the exhaust port 8. However, in the above constitution of the present embodiment, it is possible to develop a higher pressure in the vicinity of the pipe body 16. Thereby, the fluid can be supplied efficiently through the pipe body 16 to the rotor housing chamber 14.

Still further, in the fluid feeder 1 of the First Embodiment, only installation of the pipe body 16 enables to wash the surface of the rotor 10, which is quite simple in constitution and therefore highly practical. Thus, the fluid feeder is easily applicable to existing equipment.

In addition, in the fluid feeder 1 of the First Embodiment, the fluid supplied from the pipe body 16 passes through the bearing 11, thus making it possible to remove foreign matter attached to the bearing 11 as well.

In the present embodiment, a description is given of a case where the other end of the pipe body 16 is connected to the vicinity of the outer circumference (side face; of the pump casing 4. The present invention will be, however, sufficient only in supplying a fluid to the rotor housing chamber 14 through the pipe body 16 due to a difference in pressure upon rotation of the impeller 5. A position at which the other end of the pipe body 16 is connected shall not be necessarily limited to the constitution of the present embodiment.

In the present embodiment, a description is also given of a case where the fluid passes through the bearing 11. It is, however, not always necessary that the fluid passes through the bearing 11. And, for example, a flow channel by which the fluid which has passed through the clearance between the rotor 10 and the partition 13 is guided to the fluid feeding chamber 6 may be independently formed.

### 2. Second Embodiment

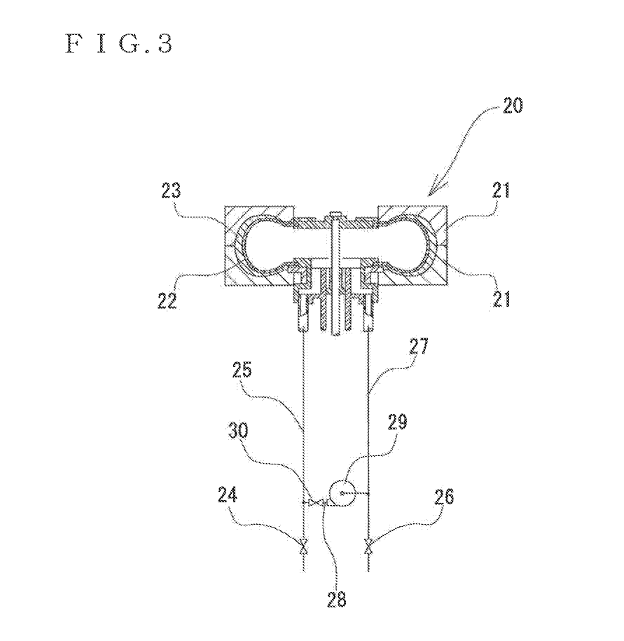

FIG. 3 is a schematic diagram which explains one example of the tire curing device to which the present invention is applied. A tire curing device 20 shown here is provided with an upper and lower mold 21 and a bladder 22 which dilates by supply of a heating fluid and contracts by discharge of the heating fluid. In this tire curing device 20, the bladder 22 which has been expanded by supply of the heating fluid (high temperature steam) is pressed to the inside of a green tire 23 set in the mold 21, thereby curing and forming the green tire 23, with the tire being held.

Further, the bladder 22 is connected to a fluid supplying pipe 25 having an on-off valve 24 and also to a fluid discharging pipe 27 having an on-off valve 26. The fluid supplying pipe 25 and the fluid discharging pipe 27 are connected to a communicatively connected pipe 28 at a position closer to the bladder 22 than the on-off valves 24, 26.

Still further, a circulation closed circuit is constituted with the bladder 22, the fluid supplying pipe 25, the fluid discharging pipe 27 and the commnunicatively connected pipe 28. A fluid feeder 29 is disposed on the circulation closed circuit (in the present embodiment, the fluid feeder 29 is disposed on the communicatively connected pipe 28). The above-described fluid feeder 1 of the First Embodiment is adopted as the fluid feeder 29.

Here, in the present embodiment, a description is given of a case where the fluid feeder 29 is disposed at some midpoint on the communicatively connected pipe 28. However, the fluid feeder 29 is disposed at least on the circulation closed circuit. It is acceptable that the fluid feeder 29 is disposed at some midpoint on the fluid supplying pipe 25 or or, the fluid discharging pipe 27. In addition, an on-off valve 30 is installed also on the communicatively connected pipe 28.

In the above-constituted tire curing device 20 of the Second Embodiment, in a state that the green tire 23 is set inside the mold 21, the on-off valves 24, 26 are opened and a heating fluid is supplied from the fluid supplying pipe 25. Then, the heating fluid flows into the bladder 22 and the on-off valves 24, 26 are closed in a state that the bladder 22 is internally filled with the heating fluid.

After the bladder 22 is internally filled with the heating fluid, the on-off valve 30 on the communicatively connected pipe 28 is opened to open up the circulation closed circuit. In this state, the fluid feeder 29 can be put into operation, by which the heating fluid is circulated inside the circulation closed circuit. Circulation of the heating fluid keeps the inside of the bladder 22 uniform in temperature.

When the green tire 23 is completely cured and molded, the on-off valves 24, 26 are opened up and the on-off valve 30 is also closed. Thereby, the fluid feeder 29 is halted and the heating fluid filled inside the bladder 22 is discharged from the fluid discharging pipe 27.

In the tire curing device to which the present invention is applied, the fluid feeder 1 of the First Embodiment is adopted as the fluid feeder 29. It is, therefore, possible to remove foreign matter attached to the surface of the rotor 10.

Further, in the tire curing device to which the present invention is applied, a blowing step (purging step) which has been performed conventionally can be omitted. It is thereby possible to cure tires at a higher yield. Hereinafter, a detailed description will be given of this point.

First, in a tire curing method using a conventional tire curing device, at a prior stage where a fluid is circulated inside a circulation closed circuit, for the purpose of discharging drain which is a heating fluid (high-temperature steam or the like) containing compositions, etc., that will deteriorate a bladder, a blowing step (purging step) in which steam, nitrogen gas, inert gas, or the like is forcibly blown into the bladder is conducted. This is to avoid a problem of attachment of foreign matter to the surface of a rotor when the fluid is circulated inside the circulation closed circuit, with the drain left inside the bladder, because the drain contains compositions, etc., that will deteriorate the bladder.

In contrast, in the tire curing device to which the present invention is applied, it is possible to remove foreign matter attached to the surface of the rotor 10. Thus, attachment of foreign matter to the surface does not become a problem, and the fluid feeder 29 can be put into operation, with the drain left inside the bladder. Omission of the blowing step (purging step) makes it possible to cure tires efficiently, without loss of heat inside the bladder 22. In particular, the drain which is a liquid is a heat source stable in temperature and realizes reduction in curing time. Further, the blowing step (purging step) can be omitted, by which it is possible to suppress consumption of steam, nitrogen gas or inert gas, etc., and also reduce costs.

### 3. Third Embodiment

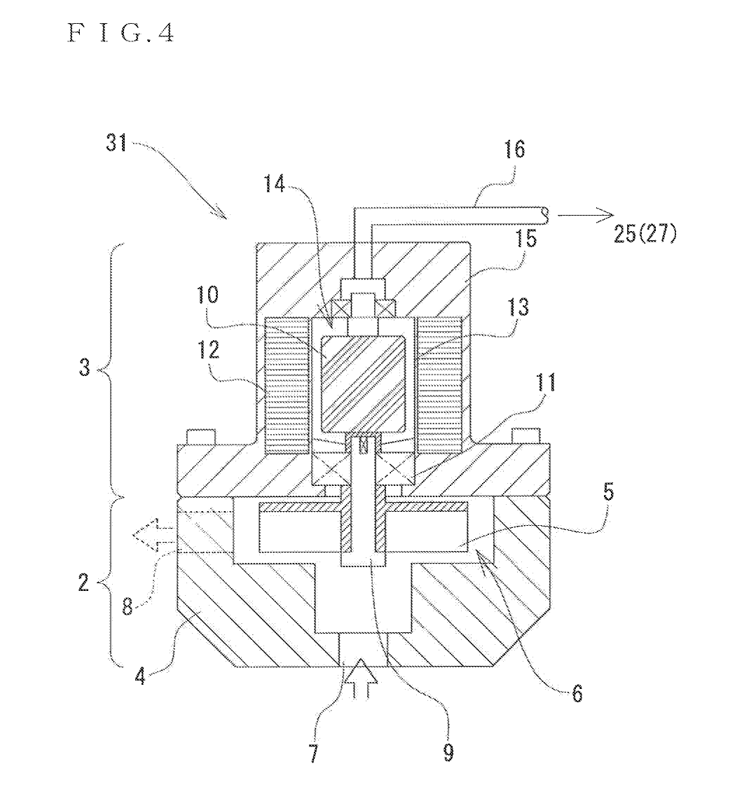

In another example of the tire curing device to which the present invention is applied, a fluid feeder 31 having the constitution shown in FIG. 4 is adopted as the fluid feeder 29. Constituent elements other than the above description are the same as those of the previously described tire curing device of the Second Embodiment.

The fluid feeder 31 shown here is different from the fluid feeder 1 of the First Embodiment in that the other end of a pipe body 16 is connected to a fluid supplying pipe 25 but other constituent elements are the same as those of the previously described fluid feeder 1 of the First Embodiment.

In the above-constituted tire curing device of the Third Embodiment, with a green tire 23 set inside the mold 21, on-off valves 24, 26, 30 are opened up to supply a heating fluid from the fluid supplying pipe 25. Then, the heating fluid flows into a bladder 22 and the on-off valves 24, 26 are closed in a state that the bladder 22 is internally filled with the heating fluid.

When the heating fluid is supplied from the fluid supplying pipe 25, the heating fluid is supplied to a rotor housing chamber 14 through the pipe body 16. Thus, the fluid which has been supplied to the rotor housing chamber 14 passes through a clearance between a rotor 10 and a partition 13 and arrives at a fluid feeding chamber 6.

After the bladder 22 is internally filled with the heating fluid, the fluid feeder 31 can be put into operation. Thereby, the heating fluid is circulated inside the circulation closed circuit and the bladder 22 is internally kept constant in temperature through circulation of the heating fluid.

When the green tire 23 is completely cured and molded, the on-off valves 24, 26 are opened up and the on-off valve 30 is also closed. Thereby, the fluid feeder 31 is halted, and the heating fluid filled inside the bladder 22 is discharged through the fluid discharging pipe 27.

In the tire curing device to which the present invention is applied, when a heating fluid is supplied from the fluid supplying pipe 25 into the bladder 22, the heating fluid is supplied to a clearance between the rotor 10 and the partition 13. It is thereby possible to remove foreign matter attached to the surface of the rotor 10.

Further, in the tire curing device to which the present invention is applied, as with the previously described Second Embodiment, it is possible to omit a conventional blowing step (purging step) and cure tires at a higher yield.

### 4. Fourth Embodiment

Still another example of the tire curing device to which the present invention is applied is different from the above-described Third Embodiment in that the other end of a pipe body 16 is connected to a fluid discharging pipe 27. However, constituent elements other than the above description are the same as those of Third Embodiment (refer to FIG. 4).

Here, in the tire curing device of the Fourth Embodiment, in a state that a green tire 23 is set inside the mold 21, on-off valves 24, 26 are opened up to supply a heating fluid from a fluid supplying pipe 25 and, then, the heating fluid flows into a bladder 22. The on-off valves 24, 26 are closed in a state that the bladder 22 is internally filled with the heating fluid.

After the bladder 22 has been internally filled with the heating fluid, an on-off valve 30 on a communicatively connected pipe 28 is opened to open up a circulation closed circuit. In this state, a fluid feeder 31 can be put into operation, by which the heating fluid is circulated inside the circulation closed circuit. The heating fluid is circulated, thereby keeping the inside of the bladder 22 constant in temperature.

After the green tire 23 is completely cured and molded, the on-off valves 24, 26 are opened up and also the fluid feeder 31 is halted. Then, the heating fluid filled into the bladder 22 is discharged through a fluid discharging pipe 27.

When the heating fluid is discharged through the fluid discharging pipe 27, the heating fluid is discharged through a pipe body 16 from a rotor housing chamber 14. A fluid of the fluid feeding chamber 6 passes through a clearance between a rotor 10 and a partition 13 and arrives at a rotor housing chamber 14. And, the fluid which has arrived at the rotor housing chamber 14 is discharged through the pipe body 16.

In the tire curing device to which the present invention is applied, when the heating fluid is discharged from the bladder 22 into the fluid discharging pipe 27, the heating fluid is supplied to the clearance between the rotor 10 and the partition 13. It is thereby possible to remove foreign matter attached to the surface of the rotor 10.

Further, in the tire curing device to which the present invention is applied, as with the previously described Second Embodiment and Third Embodiment, it is possible to omit a conventional blowing step (purging step). Therefore, tires can be cured at a higher yield.

### 5. Others

In the present embodiments, a canned electric motor is adopted. In general, a canned electric motor is unsatisfactory in motor efficiency and becomes excessively great in load depending on conditions. In order to avoid such a situation that the motor is heated up to a temperature exceeding a heat-resistant temperature due to the excessively great load, cooling is required to be performed by constant supply of air or the like. Thus, it is preferable that a thermo couple is built in the canned electric motor to control an amount of cooling air to be supplied, while an internal temperature is monitored.

Further, even when the same rotation instructions are given to an electric motor, there is a difference in rotation of an impeller depending on load of a fluid. Therefore, a sensor for confirming actual rotation of the impeller is installed (for example, a non-contact sensor) and the electric motor is controlled while actual rotation of the motor is confirmed. It is thereby possible to avoid excessive operation of the electric motor and realize an energy-saving operation.

### DESCRIPTION OF REFERENCE NUMERALS

1: fluid feeder
2: pump portion
3: motor portion
4: pump casing
5: impeller
6: fluid feeding chamber
7: suction port
8: exhaust port
9: pump driving shaft
10: rotor
11: bearing
12: stator coil
13: partition (can)
14: rotor housing chamber
15: rotor housing body
16: pipe body
20: tire curing device
21: mold
22: bladder
23: green tire
24: on-off valve
25: fluid supplying pipe
26: on-off valve
27: fluid discharging pipe
28: communicatively connected pipe
29: fluid feeder
30: on-off valve
31: fluid feeder

1. A method for removing rotor attached substances in a fluid feeder comprising:
a motor which has a rotor and a stator coil disposed around the rotor;
a rotor housing body which houses the rotor and has a first region hermetically separating the rotor from the stator coil;
a driving shaft, one end of which is connected to the rotor;
an impeller which is connected to the other end of the driving shaft;
an impeller housing body which has a second region hermetically installed so as to be connected consecutively to the first region and in which the impeller is housed at the second region;
a suction port which is installed on the impeller housing body to suck a fluid into the second region upon rotation of the impeller;
an exhaust port which is installed on the impeller housing body to exhaust the fluid from the second region upon rotation of the impeller;
a pipe body, one end of which is connected to the first region opposite to the impeller when viewed from the rotor, the other end of which is connected to a region of the second region higher in pressure than a region installed so as to be connected consecutively to the first region upon rotation of the impeller and which is formed internally hollow and
the method for removing rotor attached substances in the fluid feeder wherein
there is provided a fluid supplying step for supplying the fluid to the first region via the pipe body upon rotation of the impeller, thereby removing the substances attached to the surface of the rotor.

2-4. (canceled)

5. A fluid feeder comprising:
a motor which has a rotor and a stator coil disposed around the rotor;
a rotor housing body which houses the rotor and has a first region hermetically separating the rotor from the stator coil;
a driving shaft, one end of which is connected to the rotor;
an impeller which is connected to the other end of the driving shaft;
an impeller housing body which has a second region hermetically installed so as to be connected consecutively to the first region and in which the impeller is housed at the second region;
a suction port which is installed on the impeller housing body to suck a fluid into the second region upon rotation of the impeller;
an exhaust port which is installed on the impeller housing body to exhaust the fluid from the second region upon rotation of the impeller; and
a pipe body, one end of which is connected to a position corresponding to the first region opposite to the impeller when viewed from the rotor and also corresponding substantially to the center of the rotor, the other end of which is connected to a region positioned at the vicinity of a side face substantially opposite to a side face on which the exhaust port is installed, and which is formed internally hollow.

6-7. (canceled)

8. A fluid feeder comprising;
fluid;
a motor which has a rotor and a stator coil disposed around the rotor;
a rotor housing body which houses the rotor and has a first region hermetically separating the rotor from the stator coil;
a driving shaft, one end of which is connected to the rotor;
an impeller which is connected to the other end of the driving shaft;
an impeller housing body which has a second region hermetically installed so as to be connected consecutively to the first region and in which the impeller is housed at the second region;
a suction port which is installed on the impeller housing body to suck a fluid into the second region upon rotation of the impeller;
an exhaust port which is installed on the impeller housing body to exhaust the fluid from the second region upon rotation of the impeller; and
a pipe body, one end of which is connected to a position corresponding to the first region opposite to the impeller when viewed from the rotor and also corresponding substantially to the center of the rotor, the other end of which is connected to a region of the impeller housing body tree of the exhaust port, and which is formed internally hollow.

9. The method for removing rotor attached substances in the fluid feeder according to claim 1, wherein
in the fluid supplying step, the fluid is fed out to the pipe body from a region positioned in the vicinity of a side face substantially opposite to a side face on which the exhaust port is installed and the fluid is also supplied to the first region from a position corresponding substantially to the center of the rotor.

10. The method for removing rotor attached substances in the fluid feeder according to claim 1, wherein
in the fluid supplying step, the fluid is fed out to the pipe body at a predetermined angle in a flowing direction at which the fluid is discharged from the exhaust port.

11. The method for removing rotor attached substances in the fluid feeder according to claim 10, wherein
in the fluid supplying step, the predetermined angle is approximately 90 degrees.

12. The fluid feeder according to claim 5, wherein
the other end of the pipe body is connected at a predetermined angle in a flowing direction at which the fluid is discharged from the exhaust port.

13. The fluid feeder according to claim 12, wherein
the predetermined angle is approximately 90 degrees.

14. A method for removing rotor attached substances in a tire curing device which comprises:
a mold;
a bladder which is arranged inside the mold and constituted so as to dilate or contract by supply or discharge of a fluid;
a fluid supplying pipe which is connected to the bladder and supplies the fluid to the bladder;
a fluid discharging pipe which is connected to the bladder and discharges the fluid from the bladder;
a communicatively connected pipe which connects the fluid supplying pipe with the fluid discharging pipe in a communicating manner; and
a fluid feeder which is disposed on a circulation circuit constituted with the fluid supplying pipe, the fluid discharging pipe and the communicatively connected pipe; wherein
the fluid feeder comprises;
a motor which has a rotor and a stator coil disposed around the rotor;
a rotor housing body which houses the rotor and has a first region hermetically separating the rotor from the stator coil;
a driving shaft, one end of which is connected to the rotor;
an impeller which is connected to the other end of the driving shaft;
an impeller housing body which has a second region hermetically installed so as to be connected consecutively to the first region and in which the impeller is housed at the second region;
a suction port which is installed on the impeller housing body to suck a fluid into the second region upon rotation of the impeller;
an exhaust port which is installed on the impeller housing body to exhaust the fluid from the second region upon rotation of the impeller; and
a pipe body, one end of which is connected to the first region opposite to the impeller when viewed from the rotor, the other end of which is connected to a region of the second region which is higher in pressure than a region installed so as to be connected consecutively to the first region upon rotation of the impeller, and which is formed internally hollow, and
the method for removing rotor attached substances in the tire curing device, wherein
there is provided a fluid supplying step for supplying the fluid to the first region via the pipe body upon rotation of the impeller, thereby removing the substances attached to the surface of the rotor.

15. A tire curing device comprising;
a mold;
a bladder which is arranged inside the mold and constituted so as to dilate or contract by supply or discharge of a fluid;
a fluid supplying pipe which is connected to the bladder and supplies the fluid to the bladder;
a fluid supplying pipe which is connected to the bladder and discharges the fluid from the bladder;
a communicatively connected pipe which connects the fluid supplying pipe with the fluid discharging pipe is a communicating manner; and
a fluid feeder which is disposed on a circulation circuit constituted with the fluid supplying pipe, the fluid discharging pipe and the communicatively connected pipe; wherein
the fluid feeder comprises;
a motor which has a rotor and a stator coil disposed around the rotor;
a rotor housing body which houses the rotor and has a first region hermetically separating the rotor from the stator coil;
a driving shaft, one end of which is connected to the rotor;
an impeller which is connected to the other end of the driving shaft;
an impeller housing body which has a second region hermetically installed so as to be connected consecutively to the first region and in which the impeller is housed at the second region;
a suction port which is installed on the impeller housing body to suck a fluid into the second region upon rotation of the impeller;
an exhaust port which is installed on the impeller housing body to exhaust the fluid from the second region upon rotation of the impeller;
an exhaust port which is installed on the impeller housing body to exhaust the fluid from the second region upon rotation of the impeller; and
a pipe body, one end of which is connected to a position corresponding to the first region opposite to the impeller when viewed from the rotor and also corresponding substantially to the center of the rotor, the other end of which is connected to a region positioned at the vicinity of a side face substantially opposing to a side face on which the exhaust port is installed, and which is formed internally hollow.

16. A tire curing device comprising:
a mold;
a bladder which is arranged inside the mold and constituted so as to dilate or contract by supply or discharge of a fluid;
a fluid supplying pipe which is connected to the bladder and supplies the fluid to the bladder;
a fluid discharging pipe which is connected to the bladder and discharges the fluid from the bladder;
a communicatively connected pipe which connects the fluid supplying pipe with the fluid discharging pipe in a communicating manner; and
a fluid feeder which is disposed on a circulation circuit constituted with the fluid supplying pipe, the fluid discharging pipe and the communicatively connected pipe; wherein
the fluid feeder comprises;
a motor which has a rotor and a stator coil disposed around the rotor;
a rotor housing body which houses the rotor and has a first region hermetically separating the rotor from the stator coil;
a driving shaft, one end of which is connected to the rotor;
an impeller which is connected to the other end of the driving shaft;
an impeller housing body which has a second region hermetically installed so as to be connected consecutively to the first region and in which the impeller is housed at the second region;
a suction port which is installed on the impeller housing body to suck a fluid into the second region upon rotation of the impeller;
an exhaust port which is installed on the impeller housing body to exhaust the fluid from the second region upon rotation of the impeller; and
a pipe body, one end of which is connected to a position corresponding to the first region opposite to the impeller when viewed from the rotor and also corresponding substantially to the center of the rotor, the other end of which is connected to a region of the impeller housing body free of the exhaust port, and which is formed internally hollow.
